(19) United States
(12) Patent Application Publication
(10) Pub. No.: US 2005/0206616 A1
(43) Pub. Date: Sep. 22, 2005

(54) Video jacket, belt and badge and method of use

(76) Inventor: Franz Harary, Los Angeles, CA (US)

Correspondence Address: ARENT FOX PLLC, 1050 CONNECTICUT AVENUE, N.W., SUITE 400, WASHINGTON, DC, 20036, US

(21) Appl. No.: 11/081,813

(22) Filed: Mar. 17, 2005

Related U.S. Application Data
(60) Provisional application No. 60/553,540, filed on Mar. 17, 2004.
(60) Provisional application No. 60/580,735, filed on Jun. 21, 2004.
(60) Provisional application No. 60/580,730, filed on Jun. 21, 2004.

(51) Int. Cl. G09G 5/00

(52) U.S. Cl. 345/156

(57) ABSTRACT

Wearable multimedia delivery devices. A first variation provides a video jacket incorporating multimedia information delivery and optionally including separate power and multimedia information sources so as to minimize restriction of motion for the wearing user. In one variation, the separate power and multimedia information sources are provided on a belt coupled to a multimedia delivery component. A second variation provides a video badge wearable by a user, for example, when delivering a service, such as waitering. A third variation provides a video belt wearable by a user, for example, when deliverying a service, such as waitering.

This application claims priority to applicant's copending U.S. Provisional Patent Application Ser. No. 60/553,540 titled “VIDEO BELT AND BADGE AND METHOD OF USE” filed Mar. 17, 2004, and to applicant's copending U.S. Provisional Patent Application Ser. No. 60/580,735 titled “WEARABLE VIDEO DEVICES AND METHOD OF USE” filed Jun. 21, 2004. The entirety of each of these provisional patent applications is incorporated herein by reference.

### BACKGROUND OF THE INVENTION

1. Field of the Invention

The present invention relates to wearable display devices, and in particular to jackets, belts and badges that are wearable and that allow display of video information.

2. Background of the Technology

There remains an unmet need in the art for advertising and expression via individual users, and in particular to new devices and methods allowing individual expression. There is a further need for such methods and devices to provide new and eye catching advertising platforms, which will be noticed by an ever more jaded and over exposed audience.

In the past, the technology has not been available to place video advertising into a display small enough to be worn by a person. Although graphic badges, buttons, name tags and patches have been around for many years, none of the prior art has previously provided the opportunity for an advertiser to present an infinite amount of information to the consumer and public in an advertising platform utilizing wearers.

### SUMMARY OF THE INVENTION

For thousands of years mankind has looked to express himself via personal statements. This is predominantly executed in the form of fashion. Be it clothing, jewelry, make-up, hair styling, body modification such as tattooing, or any kind of worn accessory.

This sense of style and personal communication has been prominent as early as the Roman times. To state that fashion is an expression of personal ideas and passions is quite simply exploring the obvious. One key element, however, has acted to shape the way human beings communicate personal beliefs and personalities. That element is technology. Every time a new method arrives for producing textiles, accoutrements or accessories, this resource is embraced by fashion designers and employed by them to express personal style. One major leap forward was the invention of silk screening in the 1950's. This meant that you could print on garments cost effectively, thus allowing a whole new demographic of people to express themselves with graphic images, statements, messages, etc.

As technology advances, so does fashion and personal expression. A need has developed to integrate digital technology into fashion. However, only recently has video technology been compact, self-contained, portable and affordable enough for consumer fashion. With the advent of liquid crystal display (LCD) monitors and silicon chips powerful enough to drive the production of video imagery, the personal video screen accessory provides the next natural progression in the quest for personal expression.

One embodiment of the present invention provides a “video jacket” or “media jacket” that allows communication of multimedia information worn on a jacket. Embodiments of this variation of the present invention include, for example, a jacket-vest combination with integrated lightweight LCD technology, speakers, batteries and DVD, which together create advertising or other multimedia presentation space via a wearer or wearers, such as roaming models in high-density public spaces.

Another embodiment of the present invention provides a first securable video device, referred to interchangeably herein as a “video belt.” Embodiments of the video belt of the present invention include a self-contained LCD video screen preprogrammable to play video/audio information intended as personal expression or public advertisement.

Another embodiment of the present invention provides a second securable video device, referred to interchangeably herein as a “video badge.” Embodiments of the video badge include a small self-contained video display designed to be worn, for example, publicly by service personnel as a new advertising platform aimed at consumers or by individual users wishing to provide a new medium of expression.

Among other advantages, the present invention enables the capture, via, for example, voice or written input, of any information needed to compile a voluntary database (e.g., name, age, address, telephone) usable for diverse commercial purpose and revenue streams.

Additional advantages and novel features of the invention will be set forth in part in the description that follows, and in part will become more apparent to those skilled in the art upon examination of the following or upon learning by practice of the invention.

### BRIEF DESCRIPTION OF THE FIGURES

In the drawings:

FIGS. 1-4 present various views of exemplary video badges and components, in accordance with embodiments of the present invention;

FIGS. 5 and 6 show views of an exemplary video belt, in accordance with embodiments of the present invention; and

FIG. 7 contains a representative diagram of exemplary computer system components and features for use in accordance with the present invention.

### DETAILED DESCRIPTION

The present invention relates to video jackets, badges and belts.

Video Jacket

An embodiment of the present invention provides a video jacket (also interchangeably referred to herein as a “media jacket”) that is wearable and includes a multimedia component, such as video information. In one exemplary variation, the media jacket comprises a leather jacket with removable vest sleeves. The jacket of this variation is stylized in the genre of high-tech futuristic motorcycle wear. This is not the only costume or jacket style. Other variations provide different styles to be worn by both men and women, depending on the venue and application.

In one embodiment, the media jacket has contained within it a multimedial delivery portion, such as an LCD monitor optionally coupled to or incorporating a speaker or speakers. This monitor is powered by one or more (e.g., a network) batteries that are built in. The jacket also contains one or more speakers allowing for audio or stereo audio to play along with the video images.

In some variations, the media jacket also contains one or more (e.g., a network) of LED driven infrared beams. These beams are coupled to, for example, a microprocessor, which in turn communicates with a circuit allowing for the continuous tally of information during a preset period of time. For example, this network may provide information on the number of people who stand within a four foot radius of the jacket, as well as the amount of time that they remain within range.

Audio and video are driven via a multimedia source portion, such as a DVD player/chip that is coupled to or incorporates a power supply, such as one or more batteries. In general, most variations of the jacket are light weight and designed with components so as to be serviced easily. In some variations, the media presented via the jacket is formatted so as to allow maximum visibility and attention in whatever public venue the jacket is worn.

One exemplary innovative service that the jacket of the present invention is able to provide is the ability to reach a customer base that has to date been completely inaccessible, such as those present at a rave scene, highly private events such as the Oscars® and Emmy's, as well as sporting or concert events.

One service that the “media jacket” of embodiments of the present invention is able to provide is presentation of advertising or other information similar to that which had been solved in the past via television or radio advertising, print advertising and public signage, such as billboards, posters, fliers, and even sky writing. Thus, similar to the advent of skywriting, for example, the form of advertisement providable by the present invention was not available until the invention of certain features used, such as small, inexpensive video components.

More specifically, the media jacket of embodiments of the present invention delivers the ability to bring advertising to the public in a new way via technologies that have only recently become conducive to such applications (specifically, the video hardware has become lightweight and dependable enough to be integrated into wearable clothing, and the psychological principles pulled from illusion design that has been applied to the apparel design allow for a seemingly minimal garment).

One reason the ability to use video as a viable element in personal apparel advertising has not been viable in the past is because of the substantial amount of electronics and the weight required for the final product to work. It is the present invention's unique reconfiguration of an LCD screen along with design psychologies derived from, for example, the inventor's magical illusion designs, which allow for a piece of apparel that, although apparently small in size, secretly holds the substantial amount of electronic equipment required for the video effect to operate. In some embodiments, one functional difference is in the art design. By using lightweight technologies and by orienting the LCD video screen parallel to the length of the media jacket, the present invention maximizes the video surface on the jacket back. It is this optical illusion that allows the media jacket of some variations to be worn by, for example, female models who are not particularly strong, yet possess the professional talent to attract large groups of people.

The jacket of the present invention can be used to advertise both service and products and for direct point of purchase sales anywhere. For example, Las Vegas casinos can promote their shows or casino specials on the casino floor. Soft drinks or any other food items may be advertised in the stands of sporting events. The jacket's use can be applied to virtually any other product in existence and can also be produced for retail sale and sold as high-end fashion apparel. The attention and public focus it generates continues uninterrupted to the extent of the available battery time. Without a doubt, the present invention has the ability to capture an impromptu audience in any public place. Ultimately, this will become one use of the media jacket when employed, for example, by advertising agencies.

The media jacket of some embodiments is also very user-friendly. Its design, derived in some variations from a motorcycle jacket, for example, with extensive use of Velcro® and access zippers, allows all of the electronics to be easily accessed for repair, maintenance, and cleaning of the jacket itself. The design also actively ventilates the interior, allowing for all of the electronics to maintain a temperature conducive to their function, where necessary.

Video Belt

The video belt, in one embodiment, is a fashionable belt made in numerous styles for both men and women that features one or numerous video elements. Specifically, in one embodiment, the video displays come in the form of small LCD monitors. These monitors are self-contained, battery operated and easily maintained by the user.

The video belt of this embodiment simply allows users to express personal passions or other information via video in a real world environment. The video belt can be programmed by the user or preprogrammed by the manufacturer to display anything from popular culture icons, music videos, to sporting events, or virtually any other information that the consumer would like to display. Like the invention of the embroidery machine, the video belt allows people of all demographics to communicate information about themselves, in a fashion sense, on a whole new dynamic that has until now been unexplored.

Video Badge

Similar to the video belt, with regard to the video badge, there is an unmet need for entertainment producers and advertisers/promoters and others to find new ways to reach audiences in an ever more competitive world bombarded by advertising. Using Las Vegas as an examplary playing field, for example, there is a need for an invention that allows entertainers and others to advertise information, such as live theatrical productions, to potential ticket buyers in an intimate situation, away from the rest of the sea of advertisements already saturating Las Vegas. Specifically, there is a need for devices and methods to target the potential audience on the casino floor. There is a further need for such devices and methods to provide a psychological break from the digital noise already surrounding the public, such as may occur in the momentary interactions that take place between customers and casino employees, such as card dealers, waitresses, bartenders and change makers.

These interactions provide an ideal opportunity to reach an audience. The video badge of the present invention serves as a solution for potential consumers to see a product for a few moments, focusing away from, for example, the rest of the additional stimuli that battle for attention on the casino floor. Applications of the present invention, however, reach far beyond the casinos of Vegas and in fact lie worldwide, wherever there is a consumer base and people to service them. Other exemplary uses include wearing by restaurant employees to promote menu special items, employees at banks to highlight an aspect of their financial services, and grocery workers to identify weekly specials (interchangeably referred to herein as providing a “primary service”).

Different from a conventional badge or printed sign, the video badge of the present invention allows for a virtually endless stream of information to be presented to consumers (interchangeably referred to herein as providing “secondary multimedia information”) by a retailer or service person in a very personal one-on-one situation. Because of the self-contained and very easy to operate nature of this product, it is conducive to use by untrained workers, as well as highly skilled staff and employees.

An embodiment of the video badge includes a color LCD display controlled by a processor (e.g., a microprocessor) that is run, for example, in a Windows Pocket PC operating system. In this variation, images are stored in memory and displayed at a rate of 24 frames per second. All power comes from an on board or remotely connected battery.

The video badge of this embodiment is a small self-contained device that includes a video screen that is capable of playing video and audio programming. In one embodiment, the video badge is approximately five inches high by three inches wide and less than one inch thick, and is designed to be lightweight and durable enough to withstand the conditions it faces while being worn both by consumers and retailers. Such retailers include service people, salesmen, waitresses, bartenders, bellboys, desk, clerks, concierges, hotel maids, valets, doormen, or virtually anyone working in retail stores and restaurants, resorts, food-service establishments, entertainment or any part of the tourism industry, as well as virtually anyone in the public eye holding any amount of visibility to consumers, who may wear this badge in order to send a message to consumers.

Messages presented by retailers may include, for example, a promotion, product information, an advertising campaign, commercials, personal information, service related information, or any form of advertisement, executed in any style or format, using video or graphics.

In developing nations, especially, the competition for advertising space is so fierce, that in many cases the styles and graphic approach to the outdoor advertising is actually not only affecting but defining the look of entire cities. As early as the turn of the previous century—with the construction of the Eiffel Tower—advertisements took their place in becoming emblematic icons of entire communities. The Eiffel Tower was originally intended as an advertising landmark for the Paris Exposition of 1889. In turn, New York's Times Square, as well as Tokyo's Ginza District or even Bangkok's Pat Pong area, are each refined by advertising, both architectural and temporary.

This never-ending competition continues to burn out of control, with advertisers still looking for new platforms. When one looks at an outdoor environment or even an indoor venue, one must keep in mind the rudimentary principles of the perception and the geometry of space. Quite simply, the further an advertising platform is away from the viewing customer, the smaller it becomes to human stereoscopic sight. It is this simple formula that gives the video badge power. Where an oversized video display is visible to a large number of people at any one time, the image is predominantly small, due to the distance from which it is viewed. In turn, the video badge, although relatively small in size, is viewed at a very close range by the potential customer. When applying the geometry of perspective, the image size is virtually the same as the large displays, but at a fraction of the cost. In addition, because of this novelty, and because it is worn by another human being, the video badge lends itself as a vehicle for the most powerful form of advertising of all . . . Word-of-mouth.

Various exemplary embodiments of the present invention will now be described further in conjunction with the attached figures.

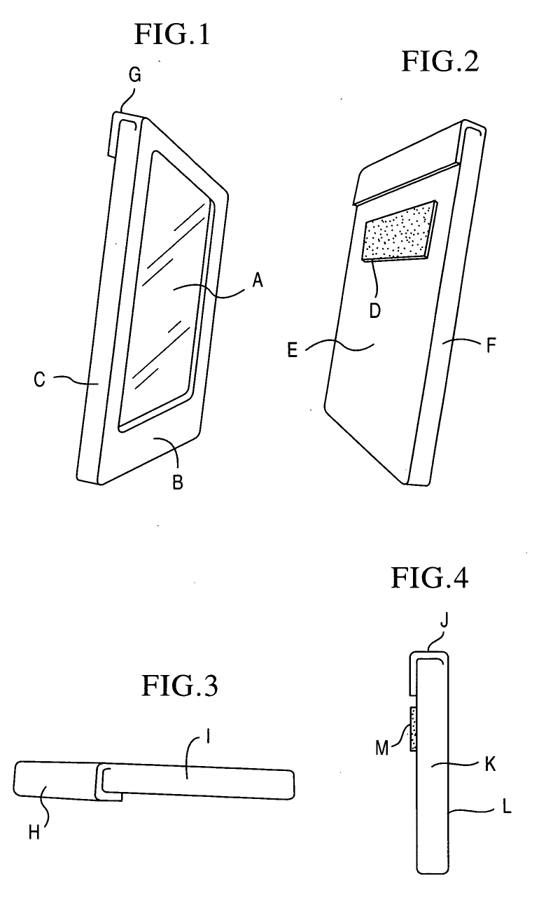

As shown in FIGS. 1-6, the self-contained video elements of the video badge and belt allow for a new medium of art as personal expression through fashion.

In one embodiment, as shown in FIGS. 1-4, the video badge includes a video display and media player that has been placed into a universal carrier designed to be fastened to clothing. The unit of this embodiment is fastenable to the wearer in a number of different ways, such as using Velcro®, snaps, buttons, pins, clips, magnets and wire. The method of adhesion is variable, depending on the garment to which it is adhered. The electronics are self-contained with or within a battery pack, for example. The image is generated via a computer chip or other processor and is programmed ahead of time via, for example, a personal computer. The video programming is designed and formatted to conform to the orientation of the video badge. This may be vertical, horizontal, or at any angle desired.

In one embodiment, the video badge is recharged in its own charger which plugs into either 110V AC or 12 DC or 220V AC.

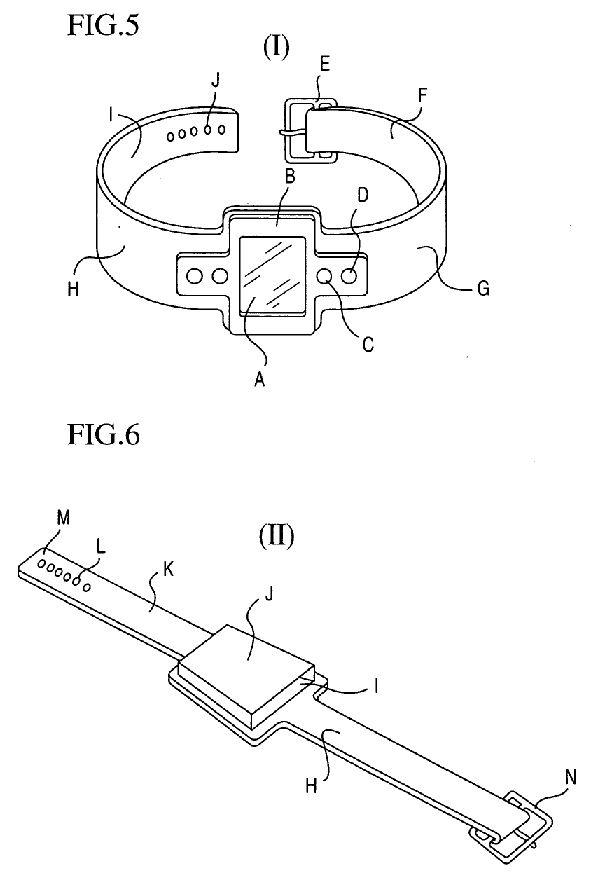

The video belt of FIGS. 5-6 is not only a solution but rather a new product servicing ongoing need. As such, one might say that one solution it achieves is to advance pop culture fashion to the next level.

The video belt, in one embodiment, includes a pocket PC that has been imbedded in a leather sleeve. This leather sleeve is visually tied into the art design of a stylized belt. The video belts, although ultimately produced in a myriad of styles and designs, all incorporate one or more of these pocket PCs. The pocket PC is preprogrammed to display the information the wearer chooses, as a personal statement or an advertising message. In the case of the latter, this message is strategically designed for maximum impact, with an understanding that the viewing public will most likely be sitting down in a restaurant or bar situation while viewing the belt display.

The belt's imagery may incorporate video or audio or a combination thereof, for example. Battery operated and self-contained, it is charged ahead of time with a self-contained charger that runs, for example, using a 12V power supply. The belt may then be activated and controlled via the touch sensitive screen that displays the data.

Worn in a public space, the video badge not only draws attention, but relays information to the consumer, in tandem with the personal interaction of the employee, service person, retailer, etc. . . . whoever is wearing it.

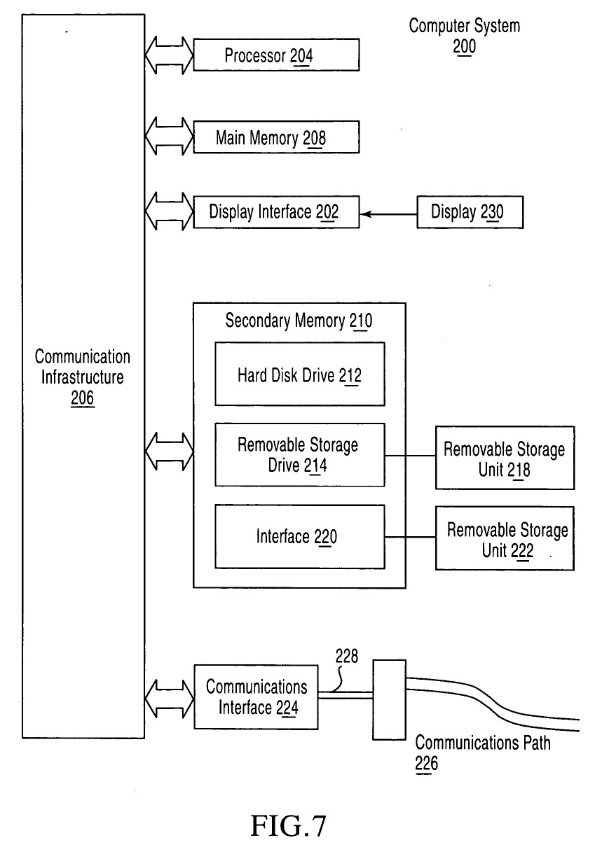

The present invention may be implemented using hardware, software or a combination thereof and may be implemented in one or more computer systems or other processing systems. In one embodiment, the invention is directed toward one or more computer systems capable of carrying out the functionality described herein. An example of such a computer system 200 is shown in FIG. 7.

Computer system 200 includes one or more processors, such as processor 204. The processor 204 is connected to a communication infrastructure 206 (e.g., a communications bus, cross-over bar, or network). Various software embodiments are described in terms of this exemplary computer system. After reading this description, it will become apparent to a person skilled in the relevant art(s) how to implement the invention using other computer systems and/or architectures.

Computer system 200 can include a display interface 202 that forwards graphics, text, and other data from the communication infrastructure 206 (or from a frame buffer not shown) for display on the display unit 230. Computer system 200 also includes a main memory 208, preferably random access memory (RAM), and may also include a secondary memory 210. The secondary memory 210 may include, for example, a hard disk drive 212 and/or a removable storage drive 214, representing a floppy disk drive, a magnetic tape drive, an optical disk drive, etc. The removable storage drive 214 reads from and/or writes to a removable storage unit 218 in a well known manner. Removable storage unit 218, represents a floppy disk, magnetic tape, optical disk, etc., which is read by and written to removable storage drive 214. As will be appreciated, the removable storage unit 218 includes a computer usable storage medium having stored therein computer software and/or data.

In alternative embodiments, secondary memory 210 may include other similar devices for allowing computer programs or other instructions to be loaded into computer system 200. Such devices may include, for example, a removable storage unit 222 and an interface 220. Examples of such may include a program cartridge and cartridge interface (such as that found in video game devices), a removable memory chip (such as an erasable programmable read only memory (EPROM), or programmable read only memory (PROM)) and associated socket, and other removable storage units 222 and interfaces 220, which allow software and data to be transferred from the removable storage unit 222 to computer system 200.

Computer system 200 may also include a communications interface 224. Communications interface 224 allows software and data to be transferred between computer system 200 and external devices. Examples of communications interface 224 may include a modem, a network interface (such as an Ethernet card), a communications port, a Personal Computer Memory Card International Association (PCMCIA) slot and card, etc. Software and data transferred via communications interface 224 are in the form of signals 228, which may be electronic, electromagnetic, optical or other signals capable of being received by communications interface 224. These signals 228 are provided to communications interface 224 via a communications path (e.g., channel) 226. This path 226 carries signals 228 and may be implemented using wire or cable, fiber optics, a telephone line, a cellular link, a radio frequency (RF) link and/or other communications channels. In this document, the terms “computer program medium” and “computer usable medium” are used to refer generally to media such as a removable storage drive 214, a hard disk installed in hard disk drive 212, and signals 228. These computer program products provide software to the computer system 200. The invention is directed to such computer program products.

Computer programs (also referred to as computer control logic) are stored in main memory 208 and/or secondary memory 210. Computer programs may also be received via communications interface 224. Such computer programs, when executed, enable the computer system 200 to perform the features of the present invention, as discussed herein. In particular, the computer programs, when executed, enable the processor 204 to perform the features of the present invention. Accordingly, such computer programs represent controllers of the computer system 200.

In an embodiment where the invention is implemented using software, the software may be stored in a computer program product and loaded into computer system 200 using removable storage drive 214, hard drive 212, or communications interface 224. The control logic (software), when executed by the processor 204, causes the processor 204 to perform the functions of the invention as described herein. In another embodiment, the invention is implemented primarily in hardware using, for example, hardware components, such as application specific integrated circuits (ASICs). Implementation of the hardware state machine so as to perform the functions described herein will be apparent to persons skilled in the relevant art(s).

In yet another embodiment, the invention is implemented using a combination of both hardware and software.

Example embodiments of the present invention have now been described in accordance with the above advantages. It will be appreciated that these examples are merely illustrative of the invention. Many variations and modifications will be apparent to those skilled in the art.

1. A method for providing secondary multimedia information using a multimedia delivery device in coincident with delivery of a primary service by a user, the method comprising:
wearably attaching the multimedia delivery device to the user, the multimedia delivery presenting the secondary multimedia information, wherein the multimedia delivery device includes a multimedia delivery portion and a multimedia source portion coupled to the multimedia delivery portion, the multimedia source portion being remotely locatable so as to minimize restriction of motion for the wearing user; and
the user performing the primary service.

2. The method of claim 1, wherein the multimedia delivery device is a video jacket.

3. The method of claim 1, wherein the multimedia delivery device is a video badge.

4. The method of claim 1, wherein the multimedia delivery device is a video belt.

5. A video badge, comprising:
a video screen wearable as a badge by a user; and
a video information source coupled to the video screen for delivery of multimedia content to the video screen.

6. A video belt device, comprising:
a video screen incorporated into a belt wearable by a user; and
a video information source coupled to the video screen for delivery of multimedia content to the video screen.
